(19) United States
(12) Patent Application Publication
(10) Pub. No.: US 2013/0199822 A1
(43) Pub. Date: Aug. 8, 2013

(54) FLEXIBLE, PERMEABLE, ELECTRICALLY CONDUCTIVE AND TRANSPARENT TEXTILES AND METHODS FOR MAKING THEM

(71) Applicants: Qinguo Fan, Dartmouth, MA (US); Okan Ala, New Bedford, MA (US)

(72) Inventors: Qinguo Fan, Dartmouth, MA (US); Okan Ala, New Bedford, MA (US)

(21) Appl. No.: 13/698,802

(22) PCT Filed: May 20, 2011
(86) PCT No.: PCT/US11/37339

§ 371 Date: Mar. 18, 2013

Related U.S. Application Data
(60) Provisional application No. 61/346,512, filed on May 20, 2010.

(51) Int. Cl. H01B 13/00; H01B 7/00

(52) U.S. Cl. CPC H01B 13/0036; H01B 7/00
USPC 174/126.1; 427/58

(57) ABSTRACT

Methods for forming a flexible, permeable, electrically conductive and substantially transparent textile utilizing vapor phase deposition are described. A number of applications of the electrically conductive textile are discussed.

### BACKGROUND

These teachings relate generally to electrically conductive polymers, and, more particularly, to electrically conductive textile.

Electrically conductive textiles can be produced in different ways such as insertion of metallic wires inside the yarns, coating the surface with metals, or incorporation of conductive fillers. However, the textile materials lose their wear, hand and comfort properties after these processes. Several approaches have been introduced to solve this problem. Among them, treatments of textile materials with conductive polymers are the most preferred solutions for the formation of electrically conductive textiles.

With the advent of conductive polymers in 1977, the interest in this field has significantly increased due to lightweight and semiconducting nature of conductive polymers enabling them to be used in applications such as microelectronics, rechargeable batteries, photovoltaic panels, light emitting diodes, electrochromic devices, electromechanical actuators, membranes, antistatic packaging, corrosion protections and biomedical applications.

Conductive polymers are usually formed on glass or other rigid substrates in many applications because of their poor mechanical properties. Many conductive polymers are rigid materials and can degrade easily. One of the approaches to address the rigidity issue is to use plastic substrates. But some applications require better mechanical properties, more flexibility, and better permeability as well as certain transparency. Therefore, the idea of using textile materials with their inherent softness, flexibility, permeability, and transparency to make a novel type of electrically conductive materials has emerged.

Among conductive polymers, poly 3,4-ethylenedioxythiophene (PEDOT) is significantly important due to its combined properties of small band gap (the energy required to excite electrons from the highest occupied state in the valence band to the lowest unoccupied state in the conduction band), high conductivity and high stability, although it should be noted that these individual properties are not limited to PEDOT. In particular, the small band gap structure enables it to be utilized in electronic applications.

PEDOT is in the group of thiophene—based conductive polymers which have relatively small band gap compared to polypyrrole, polyaniline, poly(p-phenylene vinylene) (PPV) and poly(p-phenylene) (PPP). Even though the electrical conductivity of PEDOT layers on different surfaces are lower than that of some other electrically conductive polymers mentioned above, having a small band gap structure eases the electron movement between energy levels enabling the material to be utilized in electronic applications where high electron transfer capability is required.

PEDOT can be applied on to textiles by utilizing different methods. In most cases, the aqueous dispersion of PEDOT is prepared with the help of poly(styrenesulfonate) (PSS) as a doping agent and solubilizing component. The PEDOT: PSS dispersion can be printed on textile materials utilizing different methods such as (1) screen printing in which the polymer paste is passed through a permeable screen, (2) gravure printing in which the ink pattern is formed on the fabric by engraved cylinders, and (3) inkjet printing in which the ink droplets are jetted onto the textile substrate with great precision. It is also possible to form PEDOT on textile materials by utilizing electrospinning method. The surface resistivities below 100 ohms per square of PEDOT treated textiles are sufficiently low for many electronic applications. Even though ink-jet printing PEDOT:PSS on textiles seems to be a preferable way to form conductive textiles, the surface resistivity results are not low enough.

The aqueous solutions of PEDOT exhibit short shelf life, bad film forming capability and difficulty in synthesis. Therefore, the dispersion of PEDOT is favorable over its aqueous counterpart. However, the dispersions of PEDOT (PEDOT: PSS) also exhibit lower conductivity and are influenced by water or other common solvents. Electrospun nanosize PEDOT fibers have the disadvantage of having very low mechanical properties compared to traditional textile materials.

Therefore, there is a need for methods for making textiles treated with conductive polymers that result in longer shelf life, are less influenced by water or other common solvents and have mechanical properties similar to traditional textile materials.

### BRIEF SUMMARY

Embodiments of methods for making textiles treated with conductive polymers that result in longer shelf life, are less influenced by water or other common solvents and have mechanical properties similar to traditional textile materials, conducting textile made by those embodiments and articles including the conducting textile made by those embodiments are disclosed herein.

In one embodiment, the method of these teachings for forming a flexible, permeable, electrically conductive, and substantially transparent textile includes wetting a textile sample with a predetermined chemical containing oxidant, forming an oxidant enriched textile sample, placing the oxidant enriched textile sample in a vapor phase deposition chamber having a predetermined inside temperature, providing a predetermined monomer inside the chamber, providing monomer vapor flow inside the chamber, resulting in the oxidant enriched textile sample being contacted by the monomer vapor flow and allowing contact between the oxidant enriched textile sample and the monomer vapor flow for a predetermined time, whereby an electrically conductive textile sample is formed.

In another embodiment, the method of these teachings for forming a flexible, permeable electrically conductive and substantially transparent textile includes wet-depositing, in a predetermined geometric pattern on a textile sample, a predetermined chemical containing oxidant, forming an oxidant enriched textile sample, placing the oxidant enriched textile sample in a vapor phase deposition chamber having a predetermined inside temperature, providing a predetermined monomer inside the chamber, providing monomer vapor flow inside the chamber, resulting in the oxidant enriched patterns on the textile sample being contacted by the monomer vapor flow and allowing contact between the oxidant enriched pattern on the textile sample and the monomer vapor flow for a predetermined time, whereby an electrically conductive geometric pattern is formed on the textile sample.

A number of different objects applying conductive textiles made by the methods of these treatments are also within the scope of these teachings.

For a better understanding of the present teachings, together with other and further objects thereof, reference is made to the accompanying drawings and detailed description and its scope will be pointed out in the appended claims.

### BRIEF DESCRIPTION OF THE DRAWINGS

FIG. 1 is a graphical representation of a chamber for VPP deposition;

FIG. 2 is a graphical representation of a test apparatus for surface resistivity; and

FIG. 3 depicts exemplary results Change in surface resistivity after water exposure

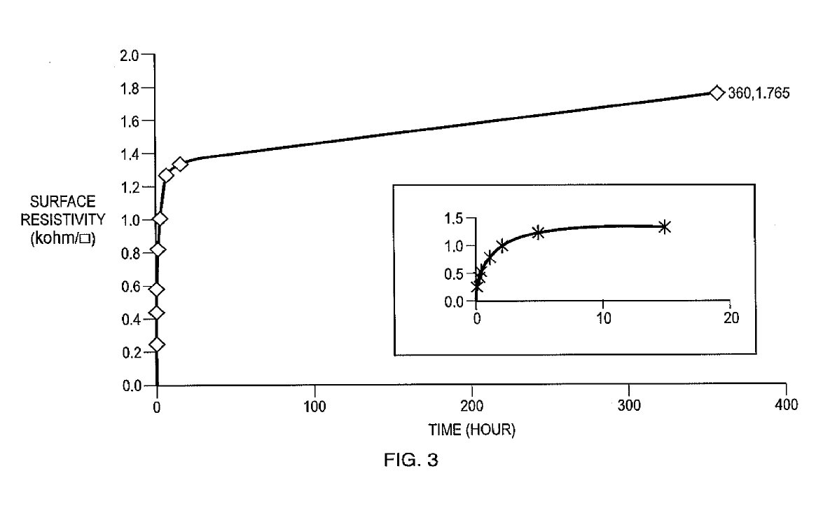

### DETAILED DESCRIPTION

The following detailed description is of the best currently contemplated modes of carrying out these teachings. The description is not to be taken in a limiting sense, but is made merely for the purpose of illustrating the general principles of these teachings, since the scope of these teachings is best defined by the appended claims.

The term “sample,” as used herein, refers to a portion or target and is not limited to being an individual portion or target, although an individual portion or target is also within the scope of these teachings. It should be noted that the term “sample,” as used herein, does not preclude the sample from being a portion or batch of material being processed by means of a continuous process. Unless otherwise stated in the claim, the process can be a process for one piece or a continuous process.

In one embodiment, the method of these teachings for forming a flexible, permeable electrically conductive and substantially transparent textile includes wetting a textile sample with a predetermined chemical containing oxidant, forming an oxidant enriched textile sample, placing the oxidant enriched textile sample in a vapor phase deposition chamber having a predetermined inside temperature, providing a predetermined monomer inside the chamber, providing monomer vapor flow inside the chamber, resulting in the oxidant enriched textile sample being contacted by the monomer vapor flow and allowing contact between the oxidant enriched textile sample and the monomer vapor flow for a (first) predetermined time, whereby an electrically conductive textile sample is formed.

In another embodiment, the step of wetting a textile sample includes the step of wet-depositing, in a predetermined geometric pattern on a textile sample, the predetermined chemical containing oxidant.

In one instance, wetting the textile sample with the predetermined chemical containing oxidant includes wetting the textile sample until saturated with the predetermined chemical containing oxidant. Saturation is determined by a number of factors including the material of the textile sample and the wetting time. In one instance, saturation can be determined by the dependence of the resistivity on the wetting time for the sample (the time over which the sample is wetted or soaked with the predetermined chemical containing oxidant); the resistivity being substantially at a lowest value at saturation.

In one instance, the method of these teachings also includes drying the electrically conductive textile sample at a predetermined drying temperature for a second predetermined time.

In another embodiment, the method of these teachings also includes drying the electrically conductive textile sample at a second predetermined temperature for a second predetermined time, rinsing the electrically conductive textile sample, in one instance for a third predetermined time and, drying rinsed electrically conductive textile sample for a fourth predetermined time.

In one instance, the predetermined inside temperature of the vapor phase deposition chamber, as well as the second predetermined temperature are selected by considering, among other factors, the variation of the resistivity of the electrically conductive textile sample with predetermined temperature and taking into consideration the textile sample used.

In one instance, the first predetermined time is selected by considering the variation of the resistivity of the electrically conductive textile sample with reaction time at a predetermined reaction temperature.

In one instance, the second or/and third predetermined time is selected by considering, among other factors, the variation of the resistivity of the electrically conductive textile sample with drying time at a predetermined drying temperature.

In one instance, selection of other predetermined parameters is effected by considering, among other factors, the variation of the resistivity of the electrically conductive textile sample as a function that parameter, other parameters being predetermined.

In one embodiment, the method provides poly-3,4-ethylenedioxythiophene (PEDOT) coated textile. In other embodiments, the method is applicable to polymerization to give other conductive polymers, such as polyanilines, polypyrroles, polythiophenes and their derivatives.

In one instance, the monomer is EDOT (3,4-ethylenedioxythiophene). In other instances, the corresponding monomer is aniline, pyrrole, thiophene or their derivatives.

In one embodiment, the oxidant is Fe(III) tosylate (ferric tosylate). Other embodiments utilizing other oxidants, such as, but not limited to, oxidants selected from the group consisting of iron(III) chloride, iron(III) toslyate, potassium iodate, potassium chromate, ammonium sulfate and tetrabutylammonium persulfate, are within the scope of these treatments.

Although the method for depositing (wetting or inkjeting) the predetermined oxidant on the textile sample in a predetermined pattern is, in the exemplary embodiment shown below, ink jet printing, other methods using a nozzle, a needle, or similar depositing mechanism are within the scope of these teachings.

Other embodiments include conductive polymer coated textiles obtained by the method of these teachings.

### Exemplification

The present teachings now being generally described, it will be more readily understood by reference to the following example, which is included merely for purposes of illustration of certain aspects and embodiments of the present teachings, and is not intended to limit these teachings.

1. VPP of EDOT on Textile Substrates

After vapor phase polymerization of EDOT, conductive polymers on textile substrates can be formed utilizing different ferric tosylate solutions. Compared to polymeric film structure, textile substrates possess higher flexibility but a low uniformity in terms of their surface morphology. To maximize the uniformity of the samples, a plain weave fabric was examined as the first sample. Thus, high permeability and better uniformity due to close interconnections between the yarns is provided. Another issue about the fabric is the liquid absorption potential that can yield better chemical solution absorption which can probably contribute to lower surface resistivity values. To increase the chemical solution absorption, a highly porous polyester/cotton (PET/COT) (50/50%) plain weave fabric was used. Apart from PET/COT fabric, 100% plain weave cotton and PET nonwoven fabrics were coated with PEDOT. Same experiments were performed for these fabrics and a comparison was made between these three fabrics. It should be noted that these teachings are not limited the above listed fabrics. Other fabrics are within the scope of these teachings.

In the case of textile materials, surface resistivity measurement is usually adopted to characterize them for electrically conductive performances. To test the surface resistivity of the fabrics, a test method, AATCC Test Method 76-2005, is used. The measuring electrodes are formed on a rigid surface, and the firm contact between the electrodes and the fabric are provided by high pressure clamps. Then, the resistivity of the fabrics which are prepared with different ferric tosylate solutions (in which either pyridine, imidazole, or other organic volatile bases is used as the inhibitor) is measured.

The conductive layer thickness and its uniformity on the surface can be investigated by SEM. Additionally, the cross sectional analysis shows how well the conductive PEDOT layer penetrates into the fiber structure. Attached to the SEM, there is EDS (energy disperse X-ray spectroscopy) instrument which can easily give the elemental composition of the conductive layer on the treated samples. By determining the iron ions' percentage on the surface, the weight of PEDOT layer on the surface, the ferric ions percentage and the surface resistivity of the sample can be correlated.

Another issue, in this case, is the transparency of the samples because the treated conductive textiles can be used for electroluminescence applications. The transparency value of different textile substrates is explored before and after they are coated with conductive polymeric layer on the surface. First, the transparency of the fabrics alone is investigated in terms of the light transmittance. Then, PEDOT-coated samples are analyzed to determine how much the conductive PEDOT layer on the surface affects the transparency of the material.

Conductive polymers are also used as sensors in several applications especially in biomechanics, sports training and rehabilitation. The change in electrical resistance due to mechanical forces applied to the treated fabric samples can be used for sensors in the physical environment. More specifically, the change in electrical resistance due to stretching of the fabric can be utilized to determine the movements of particular parts in human body such as elbows, knees, etc. In these teachings, by using an Instron 5569 tester, the change in electrical resistance of the PEDOT-coated fabric samples under mechanical stretching and release can be determined.

Since PEDOT polymer is not soluble in water, the influence of humid environment on the electrical properties of PEDOT layers formed on different textiles are expected to be lower than that of PEDOT: PSS. In these teachings, the effect of water on the electrical resistivity of the samples can be explored in certain time periods until the resistivity reaches a constant level.

1.1. Materials Used

TABLE 1
Materials and apparatus used for the experimentation

| Materials | Suppliers | Details | |
|---|---|---|---|
| EDOT (Clevious M V2) | Baytron | EDT Content | >98% |
| | | | (GC) |
| | | Viscosity | 11 mPa.s at 20 C.° |
| | | Density | 1.34 g/cm³ at |
| | | | 20 C.° |
| | | Solubility in water | 10 mbar at 90 C.° |
| Ferric tosylate powder | Sigma Aldrich | Formula weight | 677 g |
| [C₂₁H₂₁FeO₉S₃6(H₂O)] | | Product number | 462861 |
| n-butanol | | Content | ≧99.4% A.C.S. |
| | | | Reagent |
| | | Product number | 360465 |
| | | Batch number | 07892AJ |
| Ethanol | | Content | ≧99.5 A.C.S |
| | | | Reagent |
| | | Product number | 459844 |
| Pyridine | Fluka | Content | ≧99.8 A.C.S |
| | | | Reagent |
| | | Formula weight | 77 g |
| | | Product number | 434871/1 |
| Silver epoxy | Laboratory | Volume resistivity | 0.38 ohm.cm |
| | | Cure time | 10 min at 65 C.°, 4 hours at |
| | | | 24 C.° |
| | | Product number | 8831- |
| | | | 14G |
| Fabric | Laboratory | Blend | polyester/cotton (50/50%) |
| | | Weave | Plain |
| | | End per inch (EPI) | 82 |
| | | Picks per inch (PPI) | 54 |
| | | Grams per square meter (GSM) | 94 |
| | | Warp count × weft count | 40 × 40 |
| | | | Ne |
| | | Fabric thickness | 0.27 mm |
| Instron 5569 testing systems | | Capacity | 50 kN (11.250 lbf) |
| | | Speed range | 0.001-500 mm/min |
| Ohmmeter | | Keithley | 224 |
| | | | Multimeter |
| Transmittance measurement, | | High sensitivity detector | TCD1304AP |
| Ocean optics HR4000 | | Optical resolution | 0.03 nm |
| spectrophotometer | | | |
| Ultrasonic bath | | Brand | Sharpertek |
| Multimeter | | Brand | Extech MultiPro 530 True |
| | | | RMS |

| | |
|---|---|
| Ink-jet Printer | ⅛ ms, 0.9 V, 10 μs pulse width, 2.2 mm/S |

1.2. Preparation of Ferric Tosylate Solution

The ferric tosylate solution is formulated using ferric tosylate, butanol and pyridine.

The molar ratio of 0.5:1 between pyridine and ferric tosylate (40% in butanol) given in B. Winter-Jensen, D. W. Breiby, K. West, Base Inhibited Oxidative Polymerization of 3,4-Ethylenedioxythiophene with Iron(III) tosylate, Synthetic Metals, vol:152, pg:1-4, 2005, incorporated by reference herein in its entirety and for all purposes, was used.

Three different ferric tosylate solutions were prepared with different weight ratios as shown in table 2.

TABLE 2
Different ferric tosylate solutions prepared for VVP of EDOT

| Weight | Ferric Tosylate | | |
|---|---|---|---|
| Ratio | Powder Weight | Butanol | Pyridine |
| (%) | (g) | (g) | (g) |
| 40 | 1.19 | 2.5 | 0.067 |
| 30 | 1.19 | 3.3 | 0.067 |
| 20 | 1.19 | 5 | 0.07 |

1.3. Preparation of Polymerization Chamber

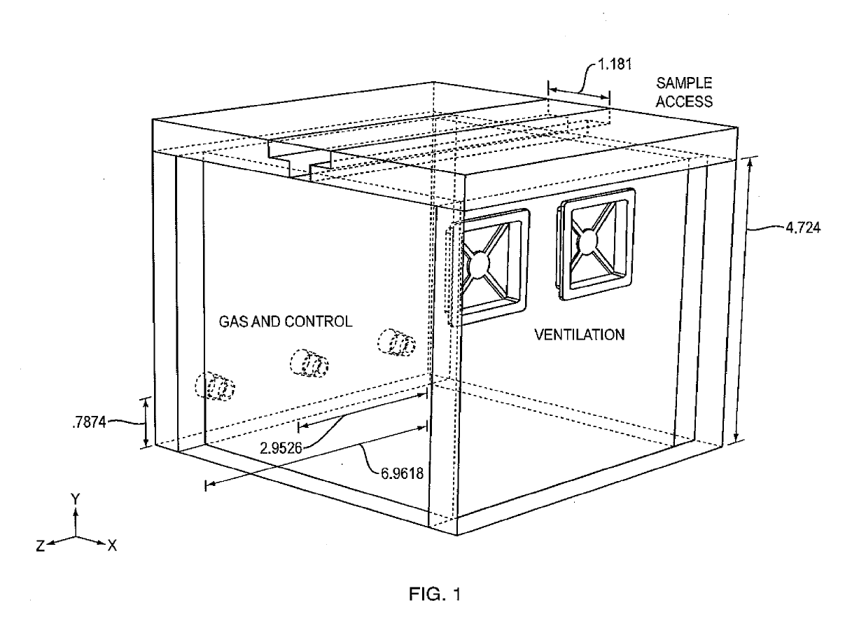

The VPP chamber, shown in FIG. 1, was prepared based on the figure given in B. Winter-Jensen, D. W. Breiby, K. West, Base Inhibited Oxidative Polymerization of 3,4-Ethylenedioxythiophene with Iron(III) tosylate, Synthetic Metals, vol:152, pg:1-4, 2005, which is Incorporated by reference herein in its entirety for all purposes. Poly(methyl methacrylate) (PMMA) is used to construct the chamber which has a total volume of 1000 cm³.

1.4. Preparation of Conductive Textiles

The PET/COT fabric was cut carefully with the dimensions of 3 cm×2 cm. To remove possible stains and to prepare the substrate, the samples were washed in ethanol/deionized water solution (30/70%). After drying the samples at 50° C. in the oven, they were washed again with deionized water. Then, the textiles samples were dried at 50° C. in the oven again and awaited in the room temperature for 2 days before they were coated with the conductive polymer.

The steps of VPP of textiles, for this exemplary embodiment, can be given as below:
1) The chamber was placed onto the heater,
2) The temperature inside the chamber was set to 50° C. and the monomer was transferred into the chamber in a small glass beaker.
3) By using Argon gas, the monomer vapor flow inside the chamber was provided.
4) The weight of the textile sample was measured.
5) By using a simple dropper, the ferric tosylate solution was dropped onto the textile substrate.
6) The weight of the ferric tosylate solution was noted.
7) The textile sample was then hung inside the chamber with the help of a hook.
8) After an hour, the PEDOT-coated textile sample was taken out from the chamber and awaited in the hood for half an hour.
9) To avoid excessive amount of ions, ethanol was used to wash the sample.
10) The textile sample was then transferred into the oven in which the temperature was adjusted to 50° C.
11) After 15 minutes, the textile sample was taken out from the oven and washed again (10 sec)
12) After second washing, the textile sample was put into the oven and dried at the same temperature for 15 min.
13) The PEDOT coated textile sample is then awaited and fixed in the room temperature for a day and resistivity measurements were made.

Three samples were prepared. The details for each sample are given in Table 3.

TABLE 3
VPP details correspondent to each sample

| | Sample 1 | Sample 2 | Sample 3 |
|---|---|---|---|
| Fabric Weight (g) | 0.070 | 0.071 | 0.067 |
| Fe (III) Tosy. Weight | 0.110 | 0.105 | 0.110 |
| (g) | | | |
| EDOT Weight (g) | 0.50 | 0.50 | 0.50 |
| Polymerization Time | 1 | 1 | 1 |
| (h) | | | |
| Temperature (° C.) | 50 | 50 | 50 |

2. Preliminary Experiments and Results

2.1. Surface Resistivity Measurements

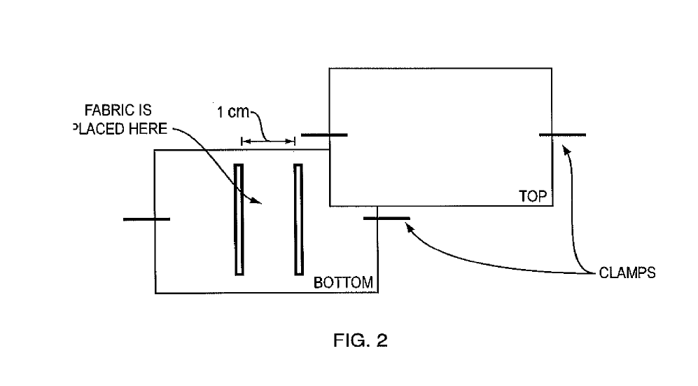

Surface resistivity tests were performed according to the test method, AATCC Test Method 76-2005. To test the electrical resistivity of the materials, silver coated copper electrodes were formed on PMMA glass template (see FIG. 2). The distance between the measuring electrodes was adjusted to 1 cm.

Electrically conductive textile materials formed via VVP of EDOT were placed on the measuring electrodes, then by using the clamps, the top template was closed over the bottom template. Thus, a firm contact between the measuring electrodes and the textile sample was provided. The measurements were made on both sides of the fabric, front and back side as mentioned in the test method. By using the equation 6, the lowest surface resistivity values were noted in Table 4. (Considering the dimensions of the fabric, the resistance values along the fabric length were multiplied by 3 and the resistance values along the width multiplied by 2)

TABLE 4
Surface resistivity values of the samples

| | | Sample 1 | | Sample 2 | | Sample 3 | |
|---|---|---|---|---|---|---|---|
| | | Length | Width | Length | Width | Length | Width |
| Front | | 307.8 | 264.8 | 224.4 | 316.4 | 260.4 | 285 |
| | | 295.8 | 237.8 | 232.8 | 292.6 | 244.5 | 291 |
| | | 298.8 | 266.8 | 237.3 | 304.6 | 252.6 | 287.6 |
| | Average | 300.8 | 256.4 | 231.5 | 304.5 | 252.5 | 287.8 |
| Back | | 314.4 | 265.4 | 234.9 | 335.6 | 269.7 | 307.8 |
| | | 321.9 | 249.2 | 229.2 | 314.6 | 262.8 | 310.2 |
| | | 313.2 | 242.6 | 241.2 | 318.2 | 254.7 | 303.4 |
| | Average | 316.5 | 252.4 | 235.1 | 322.8 | 262.4 | 307.1 |

2.2. Transmittance Measurements

For Indium Tin Oxide (ITO), PET and glass substrates, the transmittance measurements were carried out according to the spectrophotometer's manual. In the case of textile materials, before transmittance measurements, the calibration of the equipment was performed with two glass slides which are required to stabilize the textile samples. Then, the transmittance values of the treated textiles were recorded.

Among ITO, PET, glass and the textile materials, highest transmittance values were obtained with glass substrates as expected. Textile materials displayed low transmittance values compared to glass, PET and ITO. However, PEDOT coated textile materials showed a very close transmittance value to uncoated fabric indicating that the effect of PEDOT layer on the textile is not significant. If the textile material used in the present teaching is very thin, such as some veil fabrics (openwork structure), the treated textile can be well utilized as an electroluminescence device which has been demonstrated for the present teachings.

23. Water Durability Measurements

For long-term electrical stability measurements of textile materials after water treatment, there is no specific method.

In order to understand this property of the treated fabrics, a sample was used to analyze the effect of water on the surface resistivity. The treated sample was immersed in deionized water for different time periods. Between each time interval, the material was taken out from water and dried at 75° C. for 15 min. Then, it was conditioned in the laboratory where appropriate level of humidity and temperature were provided. The surface resistivity on both sides of the fabric along the length and the width were recorded by using AATCC Test Method 76-2005. The deionized water bath was refreshed and the sample was put into the refreshed water for the next immersion process.

TABLE 5.7
Surface resistivity values of PEDOT-coated textile material after water

| | Surface Resistivity (ohm/square) | | | | | | | | | | | | | |
|---|---|---|---|---|---|---|---|---|---|---|---|---|---|---|
| | 15 minutes | | 30 minutes | | 1 hour | | 2 hours | | 5 hours | | 15 hours | | 15 days | |
| | Length | Width | Length | Width | Length | Width | Length | Width | Length | Width | Length | Width | Length | Width |
| Front | 541.8 | 426.7 | 687.9 | 575.4 | 948.9 | 835.2 | 1218 | 989.4 | 1596 | 1310 | 1749 | 1378 | 2241 | 1736 |
| | 547.5 | 458.8 | 684.9 | 583.2 | 931.4 | 832.6 | 1230 | 983.6 | 1647 | 1246 | 1842 | 1362 | 2547 | 1840 |
| | 565.2 | 444.8 | 704.4 | 600.4 | 970.5 | 903.8 | 1278 | 1064 | 1611 | 1266 | 1794 | 1328 | 2334 | 1786 |
| Average | 551.5 | 443.4 | 692.4 | 586.3 | 950.2 | 857.2 | 1242 | 1012.3 | 1618 | 1274 | 1795 | 1356 | 2374 | 1787 |
| Back | 561.9 | 437 | 753.9 | 607.4 | 963.3 | 875.6 | 1266 | 1016 | 1632 | 1278 | 1839 | 1366 | 2334 | 1730 |
| | 575.4 | 454.4 | 779.1 | 601.8 | 937.8 | 785.4 | 1260 | 1118 | 1644 | 1376 | 1731 | 1362 | 2325 | 1852 |
| | 573.6 | 504.8 | 752.4 | 635.2 | 1002 | 829 | 1296 | 1102 | 1686 | 1356 | 1794 | 1408 | 2316 | 1714 |
| Average | 570.3 | 465.4 | 761.8 | 614.8 | 967.7 | 830 | 1274 | 1045.3 | 1654 | 1336.6 | 1791.3 | 1378.6 | 2325 | 1765 |

From the data shown above, it can be seen that the change in surface resistivity decreased with time. First, it increased with a huge percentage, 75.9%, considering the first surface resistivity values reported in table 5. Then, the increase in surface resistivity slowed down percentage-wise. Especially, after 5 hours of water treatment, it can be seen that the surface resistivity is almost stabilized.

In this case, the neutral pH value of deionized water is the driving force for the increase in surface resistivity of the fabric. It is known that the pH of the textile sample immediately after the VPP process is close to 1. Therefore, exposure to deionized water with a pH 7 water bath results in higher surface resistivity.

This feature of the material is important in terms of its utilization in humid environment where electrically conductive materials are expected to sustain their electrical characteristics.

2.4. Change in Resistance Via Stretching and Releasing

To run this test, the PEDOT coated textile material was placed between the clamps on the Instron tester. A copper tape is used to form the electrodes on the coated fabric which are then connected to a multimeter. The contact between the fabric and the tape was provided by the high air pressure used to close the clamps. Thus, any effects of using tougher materials for electrode formation and probe connection were avoided.

The gauge distance was set to 15 mm due to sample size, and the tests were run with maximum stretching values of 1 mm and 2 mm.

The results were graphed for both weft and warp yarn directions. Lower surface resistivity values were observed during stretching the fabric because of the increase in interconnection between the fibers. Stretching the fabric leads to a more flat fabric surface created by the fibers approaching each other within the structure.

The resistance values are very close both in the bottom and the upper peak points when the maximum stretching value is set to 1 mm. This indicates a reproducible behavior when the material is stretched and released. However, increasing the maximum stretching value to 2 mm changes the behavior of the fabric. In this case, each cycle has very different bottom and upper resistance values except the last two. This can be considered as a sign for reproducible behavior after further cyclic loading.

In the case of warp yarns, the change in resistance showed a similar characteristic. After the third loading, the highest and the minimum resistance values on each cycle is very close.

2.5 Ink-Jet Printing and VPP of EDOT

Ink jet printing and VPP of EDOT can be integrated to form electrically conductive textiles. In this case, the ferric tosylate solution was inkjeted through nozzles and then VPP process of EDOT was done as described before.

Aforementioned three ferric tosylate solutions with the percentages of 20, 30 and 40 were attempted. Among them only 20% ferric tosylate solution could be inkjeted due to its viscosity suitable for the inkjet printhead utilized, but this is not a limitation of these teachings.

After ferric tosylate injection, the fabrics were brought into the VPP chamber and the polymerization lasted for an hour. Then, washing and drying processes were done with the same temperature and time limits as described before (15 min and 50° C.).

The surface resistivity measurements were taken according to AATCC Test Method 76-2005.

TABLE 6
Details for Ink-jet printed ferric
tosylate solutions and VPP of EDOT

| | Sam- | Sam- | Sam- | Sam- | Sam- | Sam- |
|---|---|---|---|---|---|---|
| | ple 1 | ple 2 | ple 3 | ple 4 | ple 5 | ple 6 |
| Cycle of Fe (III) Tosy. | 10 | 10 | 20 | 20 | 30 | 30 |
| Weight Printed | | | | | | |
| EDOT Weight (g) | 0.10 | 0.10 | 0.10 | 0.10 | 0.10 | 0.10 |
| Polymerization Time (h) | 1 | 1 | 1 | 1 | 1 | 1 |
| Temperature (° C.) | 50 | 50 | 50 | 50 | 50 | 50 |
| Maximum Width of the | 2 | 2 | 2.5 | 3 | 3 | 4 |
| Polymer Layer (mm) | | | | | | |
| Resistivity (kohm/square) | 8.2 | 7 | 4 | 9.9 | 7.5 | 5.6 |

There is a large spectrum of potential applications of the electrically conductive textiles and the patterned electrically conductive textiles of these teachings. A number of exemplary applications are given below, these teachings not being limited to only those applications.

Electrochemical Actuators

Electrochemical actuators fabricated with conductive polymers have the advantage of lightweight, high-stress generation and low operation voltages. During electrochemical oxidation and reduction, ions and solvent molecules are transported between the polymer and the electrolyte. As a result, large dimensional changes that can generate stresses exceeding those of mammalian muscles with less than 1 V driving voltage can be seen.

The electrolyte is an essential component that provides good electroactivity and thus good polymer actuation in the electrochemical actuation system. Ideally, an electrolyte is expected to have high ionic conductivity and very good thermal and chemical stability.

Vapor and Humidity Sensors

Toxic vapor detection in industrial and battlefield environment is very important to protect human life. Microelectronic devices such as chemi-resistors have been used to control and evaluate conductive polymer involved vapor detectors. In this case, the principle is based on the absorption of the vapor which interacts with polymer chain or the dopant molecule. In order to detect, quantify and distinguish different vapors, arrays of chemi-resistors should be built in the microelectronic device which is also called electronic nose. In these devices, with the help of conductive polymers, each sensor can respond a broad class of stimuli. Additionally, differing from handheld detectors fabricated from interdigitated arrays, these devices offer improved selectivity and expanded dynamic response due to the large surface area of the fabric.

It has been shown the chemi-resistor sensor activity can detect a wide range of vapors. Depending on the change in surface conductivity, different gas sensing capabilities have been noted.

Conductive polymer monofilaments and yarns woven or stitched into the fabric structure can also be utilized in vapor detection devices. Additionally, low cost and subsequently processing of these conductive textiles could open a path for a completely textile based electronic nose. Also, massive redundancy in the garment structure increases the reliability of the system.

The concept of the effect of relative humidity on the electrical resistance in 2-acrylamido-2-methyl-1-propane sulfonic acid-doped polyaniline monofilaments has been demonstrated. Because the water adsorbed on the surface takes a role in charge transfer and does not affect the polymer backbone, the electrical conductivity increases. Since the resistance is highly reduced by the water adsorbed on the surface, humidity sensors based on polyaniline films can be fabricated.

Strain Sensors

It has been demonstrated that conventional fabrics can show piezoresistivity with a thin conductive polymer coating on the surface. In other words, the resistance of the fabrics changes significantly by a mechanical force. Polypyrrole coated Lycra/cotton fabric and polypyrrole film have been compared. It has been seen that the piezoresistivity of the fabric is more than that of the film.

The piezoresistive properties of the fabrics can be utilized in bioengineering and other related fields. The fabrication of comfortable, wearable conductive textiles could be a path for injury prevention, rehabilitation, sports technique modification and medical treatment.

Resistive Heaters

Traditionally, stainless steel or carbon fiber is embedded into the fabric structure to produce resistive heater fabrics. Heat release occurs when the fabric is supplied appropriate voltage. Because of large area radiant and direct contact heating, resistive heating fabrics could be used in some applications such as treating hypothermia and force air warmers. conductive polymer incorporated fabrics could possibly be used in heated clothing, car seats, electric heating in floors and walls by allowing the power flow directly through the fabric without any wiring.

Electromagnetic Interference Shielding

Electromagnetic compatibility is required for all electronic devices. This is a fact caused by unrestricted electronic and magnetic energy flee from one electrical device to an unintended another one. If the second device fails to operate properly, then it is called Electromagnetic Interference (EMI). Electronic devices are both sources and receptors of EMI and the electromagnetic radiation penetrating the device can malfunction it. Therefore, manufacturers must protect their devices from this effect. Shielding comes to the scene at this point. It can be achieved by several ways such as using metals or conductive fillers in composite materials. Using conductive polymers recently directed some attention in this field.

The following applications of conductive polymers are also within the scope of these teachings when used with conductive textiles of these teachings. Conductive polymers have been expected to yield several applications due to their electrical properties and wide color variation. Despite their poor mechanical properties, they have a potential to replace metallic materials in many applications attributable to their lightweight and semiconductive nature.

Antistatic Packaging

Antistatic packaging is required for most of the electronic materials to prevent electrostatic discharge (ESD) that may damage the components. The main materials in use today for packaging are ionic conductors, carbon-black filled plastics and metalized plastics. The desired properties for these applications can be given as transparency and high surface conductivity. Ionic conductors are highly transparent and have a really high surface conductivity in moist environment. However, decrease in humidity results in very low conductivity due to their nature. Carbon-black filled polymers have low surface conductivity and low transparency which is not really suitable for antistatic packaging especially in clean room environment. Metalized plastics have a similar problem in terms of transparency. conductive polymers, in this case, can be an alternative for these materials in antistatic packaging.

By using roll-to-roll method, Poly(3,4-ethylenedioxythiophene)-poly(styrene sulfonate) (PEDOT: PSS) conductive layers can be formed onto biaxially oriented PET to avoid static charges in photographic film production. PEDOT:PSS antistatic coatings can also be utilized to avoid dust contamination during manufacturing. Also, PEDOT: PSS layers are found to improve optical contrast in displays. Some applications areas for PEDOT: PSS antistatic coatings are antistatic gloves, carrier tapes, displays, textiles, antistatic release film, protective films, recording tapes and polarizers. Improving the conductivity by adding polar compounds such as ethylene glycol, dimethyl sulfoxide, sorbitol, etc which enables conductive polymers to be utilized with a desired level of surface conductivity and transparency.

Microelectronics

Conductive polymers can also be considered for microelectronics applications. In 1998, in Philips Laboratories a polymer processor chip has been fabricated in which polyaniline was used as an electrode. Microcrystalline semiconductors are more efficient than the conductive polymers considering their performance. However, conductive polymers are still good candidates due to their low cost and simplicity of the process.

The cost of thin film transistor (TFT) manufacturing can be lowered by using conductive polymers. Recently, a fully patterned all organic TFTs have been reported using PEDOT: PSS.

Rechargeable Batteries

Apart from microelectronic applications, conductive polymers could also be used in rechargeable battery technology because they can easily be charged and discharged. Usually, they are associated with lithium in the cell structure giving a voltage around 3 V. They have not been commercialized successfully subsequent to the release of other battery types such as lithium-ion. However, there is an approach introduced by John Hopkins University researchers that it may be possible to form a battery incorporating anode, cathode and electrolyte in the polymer form. In this investigation, Polypyrrole (PPy) was electropolymerized on graphite fiber substrate to be used as a composite electrode with a high surface area. Polyacrylonitrile based gel electrolyte was solution cast onto the electrodes to form an all-polymer cell. Based on the electroactive mass of the cathode and system discharge of 0.4V, a specific charge capacity of 22 mAh/g was reported.

Photovoltaic Technology

Another application area for conductive polymers is definitely solar cell technology. It has been known for a long time that solar radiation has a large potential as an energy source which can be utilized in various ways. Photovoltaic (PV) technology is based on conversion of sunlight into electricity. PV cells generate direct current electric power from semiconductors after they are illuminated by photons. Inorganic materials, silicon and other semiconductors, are used in PV cells because, by their nature, electrons in their structure can be excited from valence band into the conduction band when they are impinged by photons, and that generation leads the creation of electron-hole pairs. The electron-hole pairs at the p-n junction of the semiconductor are affected by the potential difference (which is created by the imbalance of negative and positive ions) across the junction. As a result, electrons move towards the p-type material and holes move towards the n-type material, leading to an electric current with an external circuit. To lower the manufacturing cost, organic materials which can easily be processed were seen as an alternative way for PV cell production. Organic solar cells differ from inorganic PV cells in their production technique, character of the materials used in the cell structure and the device design. In a simple organic solar cell system, an organic semiconductor which consists of donor and acceptor layers is sealed between two metallic electrodes, ITO (Indium tin oxide) and Al. MDMO-PPV: poly(2-methoxy-5-(3′,7′-dimethyloctyloxy)-1,4-phenylene-vinylene), RR-P3HT: regioregular poly(3-hexylthiophene), PCPDTBT: poly[2,6-(4,4-bis-(2-ethylhexyl)-4H-cyclopenta[2,1-b;3,4-b]-dithiophene)-alt-4,7(2,1,3benzothiadiazole) and PCBM: (6,6)-phenyl-C61-butyric acid methyl ester are some of the polymers used in the organic PV cell system. The mismatch between the electronic band structures of donor and acceptor is considered as the driving force of the electron transfer. Subsequent to the sun illumination, an electron is excited from highest occupied molecular orbital (HOMO) to the lowest unoccupied molecular orbital (LUMO) of the donor. This photoinduced electron is first transferred from the excited state of the donor to the LUMO of the acceptor and then, carried out to the Al electrode. Similarly, holes left in the HOMO of the donor are moved through the working electrode, ITO. Thus, with an external circuit, direct current is generated.

Besides the conductive polymer medium organic solar cells, PEDOT (poly(3,4-ethylenedioxythiophene)) can be used as a catalyst replacing platinum layer formed on the counter electrode in dye sensitized solar cells in which a nanosize inorganic semiconductor coated with a dye facing the electrolyte between two electrodes.

Light Emitting Diodes

The operation principle of organic solar cells can be reversed to produce light-emitting diodes (LED). Typical light emitting diodes are compound semiconductor devices and LEDs luminescence is based on the recombination of holes and electrons in a forward-biased p-n junction. When the electrons are transferred through the junction between n-type and p-type materials, the electron-hole recombination process under an electric load leads to creation of photons in the IR or visible spectrum and this process is called electroluminescence. Fabrication of inorganic semiconductors is very costly. In order to reduce the cost of the system, new materials, especially low-cost polymeric materials, were put into try. The first polymeric light emitting diodes (PLED) were presented by Richard Friend at Cambridge University in 1996. A basic PLED is comprised of ITO as the hole injecting electrode, aluminum as an electron injecting electrode and a conductive polymer system. Under the influence of electric field, the electrons were removed from the valence band (HOMO) of the polymer leaving vacancies behind themselves. The free electrons and holes move in the opposite direction in the system leading to light emitting as a result of recombination. PPV (Poly(p-phenylene vinylene)) polymer derivatives have displayed good results. Since then, plenty of progress has been made in terms of color gamut, luminance efficiency and device reliability. The motivation is to produce flat panel displays with organic materials. As a consequence, the various organic light emitting device (OLED) displays and devices have been introduced.

PEDOT was introduced as an alternative for the hole injection layer in OLEDs structure. Also, it was observed that PEDOT:PSS smoothens the surface of ITO and increase the life time of OLEDs.

In 2002 an electric razor with PLED display was introduced by Philips. Additionally, Uniax Corporation in the United States cooperated with Philips to commercialize the conductive polymer displays. Chemical modification of the polymers is still being explored by several companies including DuPont, Hoechst and Dow Chemical.

Electrochromic Devices

Conductive polymers have also been integrated into electrochromic device technology. Electrochromism can be defined as the optical property of a material or a system which is changed when the material or the system is loaded by electricity. Even though optical function could be originated by a single layer, electrochromism is usually a device property and an electrochromic device has several layers. A typical device structure consists of an electrolyte and two electrochromic films sandwiched between two conductive glass substrates. Electron insertion and extraction in cooperation with the ionic movement leads to electrochromism. Tungsten trioxide (WO₃) and iridium dioxide (IrO₂) are the most preferred inorganic electrochromic materials due to their good efficiencies.

Owing to their dynamic properties, conductive polymers can respond differently in their oxidized and reduced states. Their color transformation occurs either from a transparent (bleach) state to a colored state or from one color state to another. Compared to inorganic materials conjugated polymers have several advantages such as outstanding coloration efficiency, fast switching times, multiple colorations with the same material, tuneability of the band gap, high stability, high flexibility and low cost.

Inganas et al reported that PEDOT: PSS shows an excellent electrochemical behavior. Its color changes from slightly blue to deep blue as a result of electrochemical reduction. Reverse biasing leads to an opposite effect where the polymer is oxidized from its reduced state].

Up to now, poly thiophene derivatives have been mostly investigated due to their fast switching times and outstanding durability over other conjugated polymers. Conjugated polymers are expected to be used in smart windows and displays in near future.

Electromechanical Actuators

Electromechanical actuators are being investigated to be utilized in several applications such as medical, electronics and industrial areas. Electromechanical actuators are those materials whose physical dimensions can be changed under electric stimuli.

In 1990, Baughman et al introduced direct conversion of electrical energy into mechanical energy by using conductive polymers. He showed that conjugated polymers in their doped states display different physical characteristics that large dimensional changes occur under an electric load. In conductive polymers, dimensional changes occur due to ion movement into or out of the polymer during redox cycling. Recently, it has been proved that volume changes can be more than 10%, and the length and thickness can change more than 30%. The performance of conductive polymer actuators is favorably close to natural muscle and piezoelectric polymers in terms of the stress generated by the volume when they are tested at a constant length. Also, piezoelectric polymers require 100-200 V to be driven. On the other hand, conductive polymers only need 1-5 V to operate. The main disadvantages of the conductive polymers are slow response time and short lifetime.

Recently, electromechanical actuators have received a big interest from several companies around the world due to the fact that these actuators can be utilized as artificial muscles. Allied Signal has been working on lower power and lower voltage moving parts for micromachined optical devices. NASA is developing low power-light weight actuators for space purposes. There are some companies such as Micro-Muscle and EAMEX being involved in the development of artificial muscles. Different from others, IPRI concerned with the development of actuators to be used in electronic Braille screen.

Membranes

Membranes occupy a large percentage in separation technology, a very important growing field in industry. Trade volume of these materials in global market is approximately US$ 2.6 billion and almost 30% of it is based on polymeric materials.

The characteristics of conductive polymers enable them to be utilized in smart membrane technologies. A membrane coated or reinforced with conductive polymers can be excited in situ by electrical pulses to generate the transport of electroinactive ions, transition metal ions and small molecules. The idea of integrating conductive polymers into membrane systems was introduced by Murray and Burgmayer. They displayed that permeability of polypyrrole film changes in its oxidized and reduced states. After frequently switching the polymer in its different oxidation states, permeability of the polymers between these different states changes due to the change in density and charge. As a result, different species will pass through the polymer membrane at different rates. It is also possible to pump the ionic species electrochemically by switching the oxidized states if the polymer is synthesized using a large immobile counterion. When a large immobile ion is used, it reacts with the counterions in the surrounding electrolyte. Further oxidation of the polymer drives these counterions which may have been incorporated into polymer membrane from feed solution into the receiving side of the membrane.

Apart from the transport of ion/molecular species, conductive polymers also can be utilized to control gas permeation rate of materials. Researchers at Central Research Laboratories, Mitsubishi Rayon Co. displayed that a micro-porous membrane reinforced with a conductive polymer, polypyrrole and poly(N-methylpyrrole) in the micro-pores of Vycor glass, gives high selective gas permeation for O₂ compared to N₂ and air. In isothermal gas sorption experiments, it was observed that more amount of O₂ is transferred than that of N₂ through the conductive polymer layer.

Corrosion Protection

Corrosion is an irreversible chemical reaction between a metal or metal alloy and its environment mostly resulting in degradation of the material and its properties. According to Zarras et al, corrosion costs between 100 billion to 300 billion US$ every year. It is not easy to control the thermodynamics of the corrosion. However, slowing the kinetics and altering the mechanism of corrosion provide possible ways for controlling it.

A common way to control the corrosion is to form one or more layers on the metal surface serving as a barrier which expels water, oxygen or ions. Alternatively, a coating may act differently that it can interact chemically or electrochemically with the metal surface promoting the corrosion resistance such as hexavalent chromium for aluminum alloys and Zn particles for steel. In this case, conductive polymer coatings are considered in the group of active coatings. The conductive polymers used in corrosion resistance of metals are mostly p-doped polymers where partial oxidation takes place. As it was mentioned before, in an oxidized conductive polymer structure, there is also an anion formed to sustain the charge balance. When the anion is not mobile, it cannot be expelled after reduction. Instead, cations will be attached to the polymer to balance the charge. The oxidized form of the polymer can react with the metal when they are brought into electrical contact due to the electrically conductive nature of the polymer. When the corrosion inhibitors are incorporated as the dopant anions, electrons move from metal interface to the polymer structure to balance the charge. As a result, conductive polymer acts as an inhibitor.

Polythiophene (PTh), polyaniline (PANI) and polypyrrole (PPy) are some of the conductive polymers that can prevent metallic corrosion. According to a research, pH is also a factor that can change the corrosion prevention ability of polymers. It was shown that in lower pH, PANI coated mild steel corroded 100 times slower than the counter parts and when the pH is close to 7, the corrosion is retarded twice as slowly. However, the interaction between the conductive polymers and the metallic interface has not been clearly described yet in the case of corrosion resistance.

Biomedical Applications

Development of new materials for biomedical applications has a significant importance to promote the benefit of humans and to help them keep healthy. Highly effective stents, bone replacements, pacemakers, bionic ears and wearable prosthetics are some of these biomedical materials. The common point of these materials is that they must be compatible with the environment in which they will be implanted.

Conductive polymers have a potential to be utilized in biomedical applications at the cellular and skeletal levels. In the beginning of 1990s, growth and control of biological cell cultures on conductive polymers had been introduced. By electrical and chemical stimuli, living cells in cultures can be addressed and their growth can be controlled.

Nerve cells have become a really big interest in terms of conductive polymer applications. The ability of supporting and enhancing mammalian cell growth on their surface contributes conductive polymers a unique property. Especially, interfacing nerves and conductive polymer for implantation provides to a huge opportunity for several applications such as cochlear implants and artificial retina. Additionally, utilization of such materials is possible. In 1994, it was observed that PC12 cells can be separated and grown with the assistance of an electrically controlled release of a nerve growth factor. Later, it was shown by Langer's group that by passing a current through the structure, neurite growth on polypyrrole is possible. Then, Schmidt et al substantiated that there is a relation between fibronectins and electrochemical effects on cell growth. Subsequently, it was seen that neural glial cells can be grown on nanopeptide CDPGYIGSR attached PPy coated electrodes.

By integrating an enzyme into an electrode, biosensing devices can be created. A simple biosensor is composed of a sensing element and a transducer which transmits power from one system to another. In this case, conductive polymers can replace the transducer in the structure. The biological sensing element detects the biochemical signal coming from the analyte and the transducer converts this signal into a digital electronic signal correspondent to the amount of analyte in the environment. Glucose oxidase (GOₓ) initiated PPy films and PANI-derivative mixtures are some of the materials used so far.

In one exemplary embodiment, the resultant surface resistivity (50-75 ohm per square) is low on the PEDOT treated textiles which are still soft, flexible, and permeable, and without using rigid inorganic conductive materials like indium tin oxide (ITO) or a second polymeric component PSS, can be used in many applications such as photovoltaics and electro-luminescence. For example, a textile based electroluminescent device can be fabricated by sandwiching a layer of phosphor material with materials of these teachings as the electrodes.

It should be noted that any parameter value provided in describing the exemplary embodiments are to be considered to be known to within engineering tolerances, the measurement tolerances known in the art.

For the purposes of describing and defining the present teachings, it is noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

Although the invention has been described with respect to various embodiments, it should be realized these teachings are also capable of a wide variety of further and other embodiments within the spirit and scope of the appended claims.

What is claimed is:

1. A method for forming an electrically conductive textile, the method comprising the steps of:
wetting a textile sample with a predetermined chemical containing oxidant, thereby forming an oxidant enriched textile sample;
placing the oxidant enriched textile sample in a vapor phase deposition chamber having a predetermined inside temperature;
providing a predetermined monomer inside the chamber, thereby providing monomer vapor flow inside the chamber; resulting in the oxidant enriched textile sample being contacted by the monomer vapor flow; and
forming an electrically conductive textile sample by allowing contact between the oxidant enriched textile sample and the monomer vapor flow for a predetermined reaction time.

2. The method of claim 1 wherein the step of wetting the textile sample comprises the step of wet-depositing, in a predetermined geometric pattern on the textile sample, the predetermined chemical containing oxidant.

3. The method of claim 2 wherein the step of wet-depositing, in the predetermined geometric pattern on the textile sample, the predetermined chemical containing oxidant comprises wet-depositing with a deposition system for depositing a predetermined geometric pattern.

4. The method of claim 3 wherein the deposition system is at ink jet printing system.

5. The method of claim 3 wherein the deposition system comprises a nozzle.

6. The method of claim 1 or claim 2 wherein the step of wetting the textile sample with the predetermined chemical containing oxidant comprises wetting the textile sample until saturated with the predetermined chemical containing oxidant.

7. The method of claim 1 or claim 2 further comprising the step of drying the electrically conductive textile sample at a predetermined drying temperature for a predetermined drying time.

8. The method of claim 1 or claim 2 further comprising the steps of:
drying the electrically conductive textile sample at a predetermined drying temperature for a predetermined drying time;
rinsing, after drying, the electrically conductive textile sample; and
drying the rinsed electrically conductive textile sample for another predetermined drying time.

9. The method of claim 8 wherein the step of rinsing, after drying, comprises the step of rinsing, after drying, the electrically conductive textile sample for a predetermined rinsing time.

10. The method of claim 1 or claim 2 wherein the monomer comprises EDOT (3,4-ethylenedioxythiophene); and wherein the electrically conductive textile sample comprises PEDOT (poly-3,4-ethylenedioxythiophene).

11. The method of claim 1 or claim 2 wherein the predetermined chemical containing oxidant comprises ferric tosylate.

12. An electrically conductive fabric made by the method of claim 1 or claim 2.

13. An article comprising an electrically conductive textile made by the method of claim 1 or claim 2.

14. The article of claim 13 wherein the article is an electrochemical actuator.

15. The article of claim 13 wherein the article is a vapor and/or humidity sensor.

16. The article of claim 13 wherein the article is a strain sensor.

17. The article of claim 13 wherein the article is a resistive heater.

18. The article of claim 13 wherein the article is and electromagnetic interference shielding material.

19. The article of claim 13 wherein the article is an antistatic packaging material.

20. The article of claim 13 wherein the article is a circuit.

21. The article of claim 20 wherein the electrically conductive textile provides conductors between components.

22. The article of claim 20 wherein the electrically conductive textile provides electrode in an integrated circuit.

23. The article of claim 13 wherein the article is a rechargeable battery.

24. The article of claim 13 wherein the article is photovoltaic device.

25. The article of claim 13 wherein the article is a light emitting device.

26. The article of claim 13 wherein the article is an electrochromic device.

27. The article of claim 13 wherein the article is an electromechanical actuator.

28. The article of claim 13 wherein the article is a membrane system.

29. The article of claim 28 wherein the membrane system is utilized to control gas permeation rate.

30. The article of claim 13 wherein the article is utilized to control corrosion.

31. The article of claim 13 wherein the article is biomedical device.

32. The article of claim 13 wherein the article is a biosensing device.

33. The article of claim 13 wherein the article is an electroluminescent device.
